(19) United States
(12) Patent Application Publication
(10) Pub. No.: US 2005/0285842 A1
(43) Pub. Date: Dec. 29, 2005

(54) Liquid crystal display device and method of driving the same

(76) Inventors: Sin Ho Kang, Suwon-shi (KR); Tae Hun Kim, Chilgok-gun (KR)

Correspondence Address: MCKENNA LONG & ALDRIDGE LLP;Song K. Jung, 1900 K Street, N.W., Washington, DC, 20006, US

(21) Appl. No.: 11/165,054

(22) Filed: Jun. 24, 2005

(30) Foreign Application Priority Data
Jun. 25, 2004 (KR) P2004-48161

(51) Int. Cl. G09G 3/36

(52) U.S. Cl. 345/103

(57) ABSTRACT

A liquid crystal display device and a method of driving the same are disclosed, enabling to prevent a flickering phenomenon of the liquid display device using a data drive IC having an odd number of channels. The liquid crystal display device includes a liquid crystal panel having a plurality of gate lines crossing a plurality of data lines, a timing controller for outputting a first polarity control signal; a signal reverser for outputting a second polarity signal reversed from the first polarity control signal; a plurality of first data drive ICs receiving the first polarity control signal and outputting a data signal of a first polarity pattern to first data lines among the data lines; and a plurality of second data drive ICs receiving the second polarity control signal and outputting a data signal of a second polarity pattern to second data lines among the data lines, the second polarity pattern being contradictory to the first polarity pattern.

This application claims the benefit of Korean Application No. P2004-48161, filed on Jun. 25, 2004, which is hereby incorporated by reference for all purposes as if fully set forth herein.

### BACKGROUND OF THE INVENTION

1. Field of the Invention

The present invention relates to a liquid crystal display device, and more particularly to a liquid crystal display device and a method for driving the same that prevents flickering in liquid crystal display device provided with a data drive IC having an odd number of channels.

2. Discussion of the Related Art

A related liquid crystal display device displays an image by controlling light transmittance of a liquid crystal using an electric field. For this reason, the liquid crystal display device includes a liquid crystal panel having a plurality of liquid crystal cells arranged in an active matrix and a driving circuit for driving the liquid crystal panel.

The liquid crystal display device includes a plurality of data drive integrated circuits (ICs) connected with the liquid crystal panel through a data tape carrier package (TCP) and a plurality of gate drive integrated circuits (ICs) connected with the liquid crystal panel through a gate TCP.

The liquid crystal panel includes a thin film transistor formed at each crossing of plurality of gate lines and a plurality of data lines, as well as a liquid crystal cell connected with the thin film transistor.

A gate electrode of the thin film transistor is connected to one of the plurality of gate lines, and a source electrode is connected to one of the plurality of data lines. The thin film transistor supplies a data signal from the data line to the liquid crystal cell in response to a gate drive pulse from the gate line.

The liquid cell includes a pixel electrode connected with a drain electrode of the thin film transistor, and a common electrode facing the pixel electrode and having the liquid crystal therebetween. The liquid crystal cell controls light transmittance by driving the liquid crystal in response to the data signal supplied to the pixel electrode.

Meanwhile, each of the plurality of gate drive ICs is soldered into each of the plurality of gate TCPs. Each of the gate drive ICs soldered into each of the gate TCPs is electrically connected with each of a plurality of gate pads of the liquid crystal panel through the gate TCP. The gate drive ICs sequentially drive the gate lines of the liquid crystal panel by one horizontal time period (1H). Each of the data drive ICs is soldered into each of the data TCPs. Each of the data drive ICs soldered into each of the data TCPs is electrically connected to each of the data pads of the liquid crystal panel through the data TCP. The data drive ICs convert digital pixel data into an analogsignal, and then supply the converted analog signal to the data lines of the liquid crystal panel by 1 horizontal time period (1H).

Hereinafter, the data drive IC of the related art liquid crystal display device will be described referring to the included drawings. FIG. 1 illustrates a block diagram showing a data drive IC of the conventional liquid display device. FIG. 2a and FIG. 2b illustrate a timing diagram of a driving signal for driving the data drive IC of FIG. 1.

Each of the plurality of data drive ICs of the related art liquid crystal display device includes a shift register array 12 for sequentially supplying sampling signals, first and second latch arrays 16 and 18 for latching and outputting pixel data in response to the sampling signals of the shift register array 12, a first multiplexer 15 (hereinafter referred to as MUX) disposed between the first and second arrays, a digital analog converter array 20 (hereinafter referred to as DAC) for converting pixel data from the second latch array 18 into data signals, a buffer array 26 for buffering data signals from the DAC array 20 and outputting the buffered data signals, and a second MUX array 30 for selecting a channel for an output of the buffer array 26.

The data drive IC further includes a data register unit 34 for relaying pixel data (R, G and B) supplied from a timing controller (not illustrated), and a gamma voltage unit 36 for supplying positive and negative gamma voltages needed from the DAC array 20.

Each of the data drive ICs mentioned above has ‘n’ channel (for example, 384 or 480) data outputs for driving ‘n’ number of data lines.

Operation of the related art data drive IC mentioned above will be described. First, the data register unit 34 relays pixel data from the timing controller to the first latch array 16. Particularly, the timing controller divides the pixel data into even pixel data (RGBeven) and odd pixel data (RGBodd) and then supplies the pixel data to the data register unit 34 through each transmitting line.

The data register unit 34 outputs the inputted even pixel data (RGBeven) and odd pixel data (RGBodd) to the first latch array 16 through each transmitting line. In this case, each of the even pixel data (RGBeven) and the odd pixel data (RGBodd) includes red (R), green (G) and blue (B) pixel data.

Meanwhile, the gamma voltage unit 36 divides a plurality of gamma standard voltage by a gray level and outputs the voltage, the gamma standard voltage inputted from a gamma standard voltage generator (not illustrated).

The shift register array 12 comprises n/6 number of shift registers, including the first shift register 14, so as to sequentially generate sampling signals and supply the signals to the first latch array 16. As illustrated in FIGS. 2A and 2B, the first shift register 14 outputs a source start pulse (SSP) as a sampling signal by shifting the source start pulse (SSP) according to a source sampling clock signal (SSC), the source start pulse (SSP) inputted from the timing controller, and then supplies the shifted source start pulse (SSP) as a carry signal (CAR) to the next shift register.

The source start pulse (SSP) is supplied in one horizontal time period unit (1H) and output as a sampling signal after being shifted at each source sampling clock signal (SSC) as illustrated in FIGS. 2a and 2b.

The first latch array 16 samples pixel data (RGBeven and RGBodd) from the data register unit 34 in response to the sampling signal from the shift register array 12, and then latches the sampled pixel data. The first latch array 16 includes ‘n’ number of first latches 13 so as to latch ‘n’ number of pixel data (R, G, and B) bits, and each of the first latches 13 has a size corresponding to a bit number (3 or 6 bits) of the pixel data (R, G, and B data).

The first latch array 16 takes a sample of even RGB (RGBeven) and odd RGB (RGBodd) for a total of six pixel data for each sampling signal so as to latch and output the signal.

The MUX array 15 determines a proceeding channel of the pixel data (R, G and B) supplied from the first latch array 16 in response to a polarity control signal from the timing controller. For this reason, the first MUX array 15 includes ‘n−1’ number of first MUXs 17. Each of the first MUXs 17 inputs two adjoining outputs of the first latch 13, and selectively outputs one according to the polarity control signal (POL).

In this case, other than the first and last ones of the first latches 13, each of the remaining outputs of the first latches 13 is shared by the two of the first MUX 17 and are inputted. Outputs from the first and last ones of the first latches 13 are shared by the second latch arrays 18 and the first MUX 17. The first MUX array 15 having such a structure controls the pixel data (R, G, and B) from each of the first latches 13 directly to the second latch array 18 according to the polarity signal (POL), or to the second latch array 18 after first shifting one column to the right.

The Polarity of the polarity signal (POL) is reversed every horizontal time period (1H) as illustrated in FIGS. 2a and 2b. Accordingly, the first MUX array 15 controls the polarity of the pixel data (R, G, and B) by passing each of the pixel data (R, G and B) from the first latch array 16 through the second latch array 18 in response to the polarity control signal (POL), and then outputting the data to a positive DAC 22 or negative DAC 24 of the DAC array 20.

In response to a source output enable signal (SOE) from the timing controller, the second latch array 18 simultaneously latches and outputs the pixel data (R, G and B) passed through the first latch array 16 and the first MUX array 15 and then inputted thereto. The second latch array 18 includes a plurality of second latches 19 to which the pixel data (R, G and B) from the first latch array 16 is light shifted and inputted.

In this case, the source output enable signal is generated every horizontal time period (1H) as illustrated in FIGS. 2A and 2B. The second latch array 18 simultaneously latches the pixel data (R, G and B) inputted from a rising edge of the source output enable signal (SOE), and then outputs the data at a falling edge thereof.

The DAC array 20 converts the pixel data (R, G and B) from the second latch array into data signals using positive (+) and negative (−) gamma voltages (GH and GL) from gamma voltage unit 36, and outputs the converted signals.

For this reason, the DAC array 20 includes n+1 PADC 22 and NDAC 24, and alternatively disposes the PADC 22 and the NDAC 24 in parallel. The PDAC 22 converts the pixel data (R, G and B) from the second latch array 18 into positive (+) data signals using the positive gamma voltages (GH). The NDAV 24 converts the pixel data (R, G and B) from the second latch array 18 into negative (−) data signals using the negative gamma voltages (GL).

In addition, each of n+1 number of buffers 28 included in the buffer array 26 buffer the data signals output from each of the PADC 22 and the NDAC 24 of the DAC array 20.

In response to the polarity control signal from the timing controller, the second MUX array 30 determines the proceeding channel for the data signal supplied from the buffer array 26.

For this reason, the second MUX array 30 includes an n number of second MUXs 32. Each of the second MUXs 32 selects one output of the two adjoining buffers 28 in response to the polarity control signal (POL), and outputs the output to a corresponding data line (D).

In this case, the outputs of the rest of the buffers 28 except first and last buffers 28 are shared by two adjoining second MUXs 32, and then inputted.

In response to the polarity control signal (POL), the second MUX array 30 outputs data signals which are received from each of the buffers 28 except the last buffer to a data line (DL1-DL6) by one-to-one correspondence.

And then, in response to the polarity control signal (POL), the second MUX array 30 outputs data signals which are received from each of the buffers 28 except the first buffer to a data line (DL1-DL6) by one-to-one correspondence.

Similar to the case of the first MUX array 30, the polarity of the polarity control signal (POL) is reversed every horizontal time period (1H) as illustrated in FIGS. 2a and 2b. Accordingly, the second MUX array 30 determines the polarity of the data signal supplied to the data line (D1 or D6) in response to the polarity control signal along with the first MUX array 15. As a result, the data signal supplied to each of the data lines (D1 or D6) through the second MUX array 30 has polarity opposite to that of the adjoining two data signals.

In other words, as illustrated in FIGS. 2a and 2b, data signals output to the odd data lines (Dodd) such as DL1, DL2 and DL5 have opposite polarity to the data signals output to even data lines (Deven) such as D2, D4 and D6. Polarities of the odd data lines (Dodd) and the even data lines are reversed every horizontal time period (1H) during which the gate lines GL1, GL2, GL3, etc. are sequentially driven.

As an example, when the polarity control signal having high logic value is applied to the first and second MUX arrays 15 and 30, positive data signals are applied to the odd data lines (Dodd), and negative data signals are applied to the even data lines (Deven). When the polarity control signal having a low logic value is applied to the first and second MUX arrays 15 and 30, negative data signals are applied to the odd data lines (Dodd), and positive data signals are applied to the even data lines (Deven).

Accordingly, positive data signals are applied to odd liquid crystal cells connected with each of the odd data lines (Dodd) among the liquid crystal cells on one horizontal line, and negative data signals are applied to even liquid crystal cells connected with each of the even data lines (Deven) among the liquid crystal cells on the horizontal line.

In this case, each of the data drive ICs includes an even number or an odd number of output lines, and each of the output lines is connected one-to-one to the data line so as to output a data signal.

In other words, when each of the data drive ICs has an even number of output lines, each of the drive ICs divides the total number of data lines into even numbered groups, and then drives the divided data lines. When each of the data drive IC has an odd number of output lines, each of the drive ICs divides the output lines into odd numbered output lines, and then drives the divided data lines.

FIG. 3 illustrates a schematic diagram of a related art data drive IC having an even number of output lines, and FIG. 4 illustrates a schematic diagram of a conventional data drive IC having an odd number of output lines.

As illustrated in FIG. 3, when each of the data drive ICs 61a, 61b, 61c, an 61d has an even number of output lines 70, and each of the output lines 70 alternatively outputs positive data signals and negative data signals (the dot inversion method), the number of the output lines 70 of each of the data drive ICs 61a, 61b, 61c, and 61d is an even number, and thus each of the output lines has the same number of positive data signals and negative data signals.

The polarity of the data signals output from the first output line 70a of an arbitrary data drive IC 61b is the opposite of that of the data signals output from the last output line 70b.

Accordingly, the polarity of data signals output from the first output line 70a of the arbitrary data drive IC 61b is the opposite of that of data signals output from the last output line 70b of the data drive IC 61a in a previous column. In the same manner, the polarity of data signals output from the last output line 70b of the arbitrary data drive IC 61b is the opposite of that of the data signals output from the first output line 70a of the data drive IC 61c in a next column.

As illustrated in FIG. 4, when each of the data drive ICs 81a, 81b, 81c, and 81d has an odd number of output lines 90, and data signals are output in the dot inversion method, the number of each of the data drive ICs 81a, 81b, 81c, and 81d is an odd number, and thus the output lines of the arbitrary data drive IC 81b have different numbers of positive data signals and negative data signals

Data signals output from a first output line 90a of the arbitrary data drive IC 81b has the same polarity as that of the data signals output from the last output line 90b thereof.

Accordingly, the polarity of data signals output from the first output line 90a of an arbitrary data drive IC 81a is same as that of the data signals output from the last output line 90b of the data drive IC 81a in a previous column. In the same manner, the polarity of data signals output from a last output line 80b of the arbitrary data drive IC 81b is same as that of data signals output from the first output line 90a of the data drive IC 81c in a next column.

As a result, when a liquid crystal panel is driven using data drive ICs 81a, 81b, 81c, and 81d having odd number of output lines as mentioned above, a liquid crystal cell 52 applied with data signals through the first output line 90a of the arbitrary data drive IC 81b has same polarity as that of liquid crystal cell 51 applied with data signals through the last output line 90b of the data drive IC 81a as illustrated in FIG. 5.

In the same manner, liquid crystal cell 53 applied with data signals through the last output line 90b of the arbitrary data drive IC 81b has the same polarity as that of liquid crystal cell 54 applied with data signals through the first output line 90a of the data drive IC 81c in a next column.

In the end, when the data drive ICs 81a, 81b, 81c, and 81d having an odd number of output lines are used, the polarity of liquid crystal cells 91 and 92 is the same as that of the liquid crystal cells 93 and 94, which are the liquid crystal cells applied with data signals output from the first and last output lines 90a and 90b among the adjoining data drive ICs 81a, 81b, 81c, and 81d.

### SUMMARY OF THE INVENTION

Accordingly, the present invention is directed to a liquid crystal display device and a method of driving the same that substantially obviates one or more problems due to limitations and disadvantages of the related art.

An advantage of the present invention is to provide a liquid crystal display device and a method of driving the same in which odd numbered data drive ICs and even number data drive ICs have opposite polarity patterns so as to reverse the polarities of adjoining liquid crystal cells.

Additional advantages of the invention will be set forth in part in the description which follows and in part will become apparent to those having ordinary skill in the art upon examination of the following or may be learned from practice of the invention. These and other advantages of the invention may be realized and attained by the structure particularly pointed out in the written description and claims hereof as well as the appended drawings.

To achieve these and other advantages and according to the purpose of the invention, as embodied and broadly described herein, a liquid crystal display device includes a liquid crystal panel having a plurality of gate lines and a plurality of data lines crossing a timing controller for outputting a first polarity control signal, a signal reverser for outputting a second polarity signal reversed from the first polarity control signal, a plurality of first data drive ICs receiving the first polarity control signal and outputting a data signal of a first polarity pattern to first data lines among the data lines, and a plurality of second data drive ICs receiving the second polarity control signal and outputting data signals of a second polarity pattern to second data lines among the data lines, the second polarity pattern being contradictory to the first polarity pattern.

In another aspect of the present invention, a method of driving a liquid crystal display device includes the steps of receiving a first polarity control signal and outputting a data signal of a first polarity pattern to first data lines among a plurality of data lines, and receiving a second polarity control signal and outputting a data signal of a second polarity pattern to second data lines among the data lines, the second polarity pattern being contrary to the first polarity pattern.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a block diagram showing a data drive IC of a related art liquid display device;

FIGS. 2a and 2b illustrate a timing diagram of a driving signal for driving the data drive IC of FIG. 1;

FIG. 3 illustrates a schematic diagram of a related art data drive IC having an even number of output lines;

FIG. 4 illustrates a schematic diagram of a related art data drive IC having an odd number of output lines;

FIG. 5 illustrates a diagram showing a polarity pattern displayed on a liquid crystal panel when a related art drive IC is used;

FIG. 6 illustrates a schematic diagram of a liquid crystal display device according to a first embodiment of the present invention;

FIG. 7 illustrates a schematic diagram showing a liquid crystal display device according to a second embodiment of the present invention;

FIG. 8 illustrates a schematic diagram showing a liquid crystal display device according to with a third embodiment of the present invention;

FIG. 9 illustrates a schematic diagram showing a circuit structure of an inverter having a signal converter;

FIG. 10 illustrates a timing diagram of first and second polarity reversing signals;

FIG. 11 illustrates a diagram showing a polarity pattern displayed on a liquid crystal panel when a drive IC according to the present invention is used.

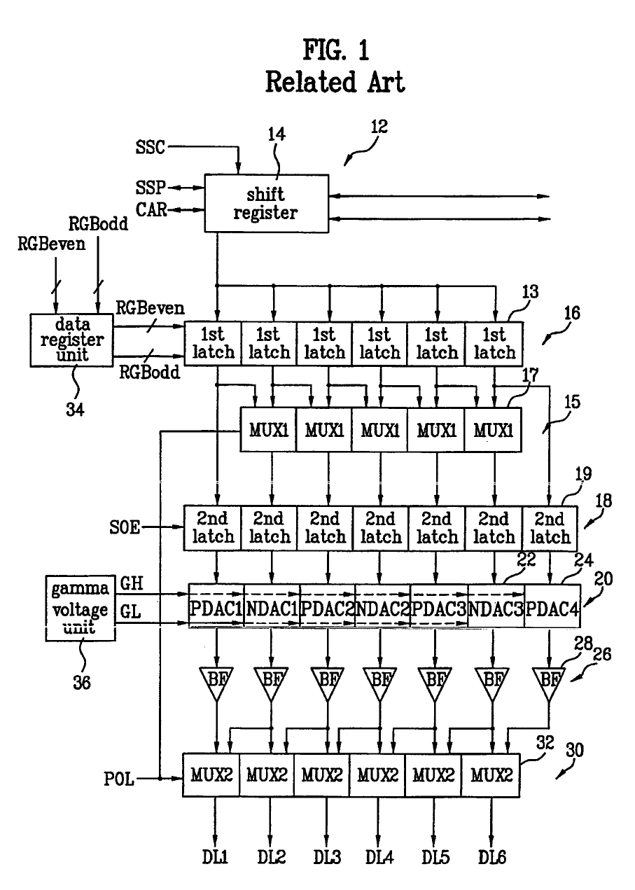

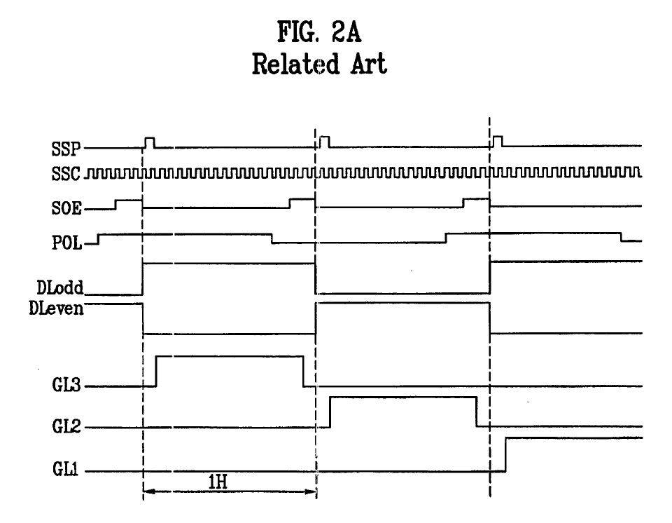

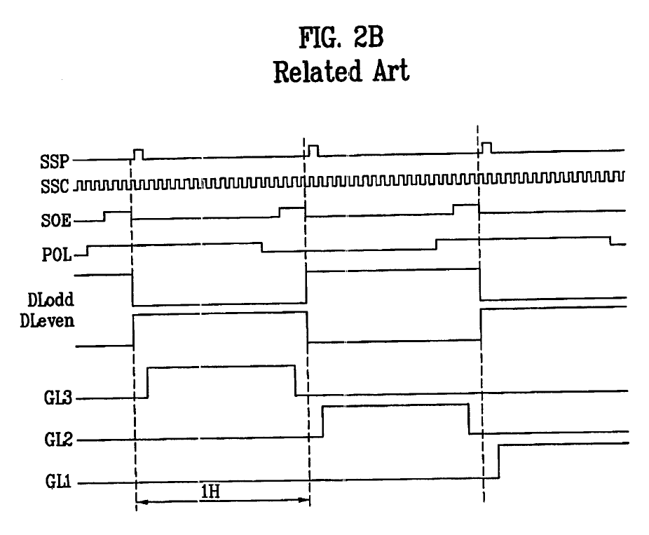

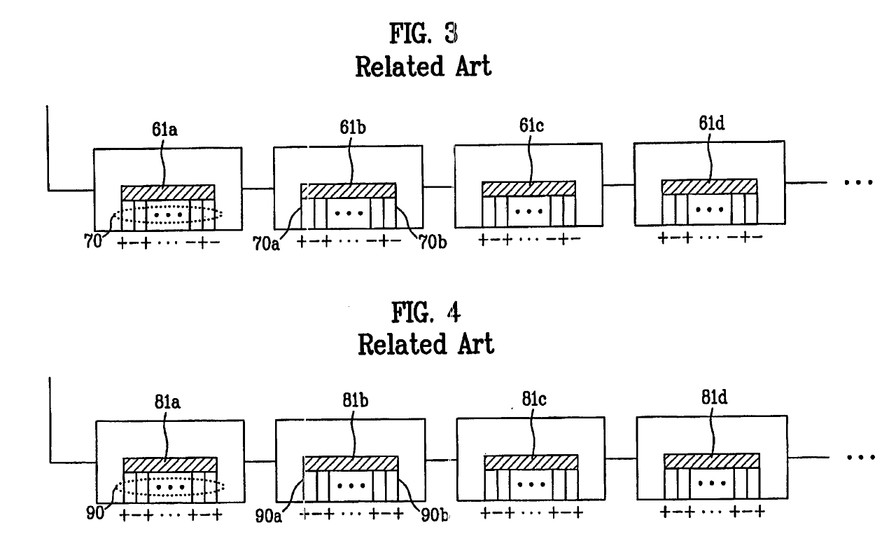

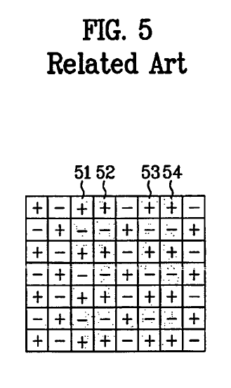

### DETAILED DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

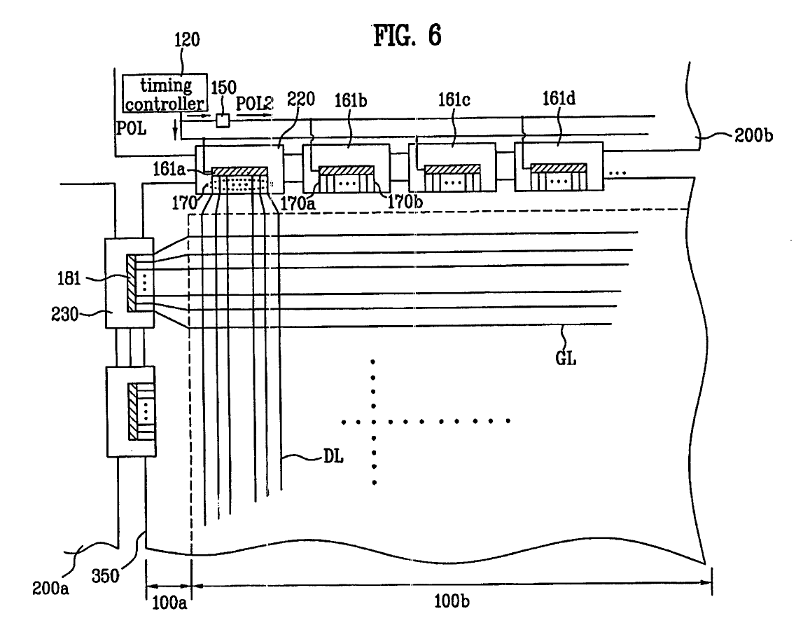

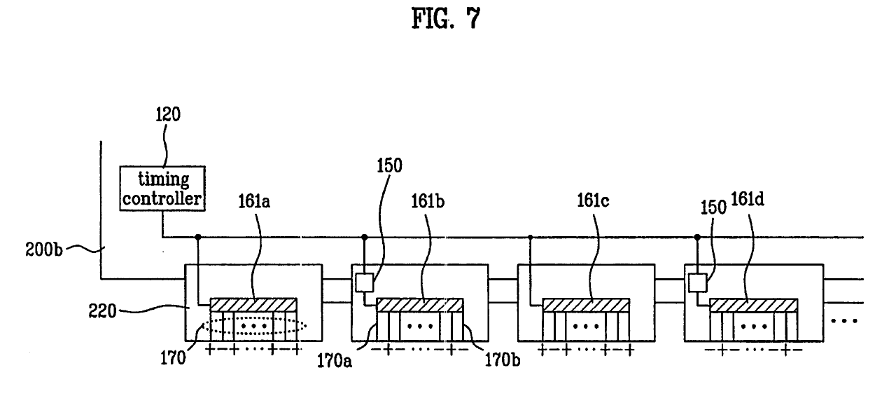

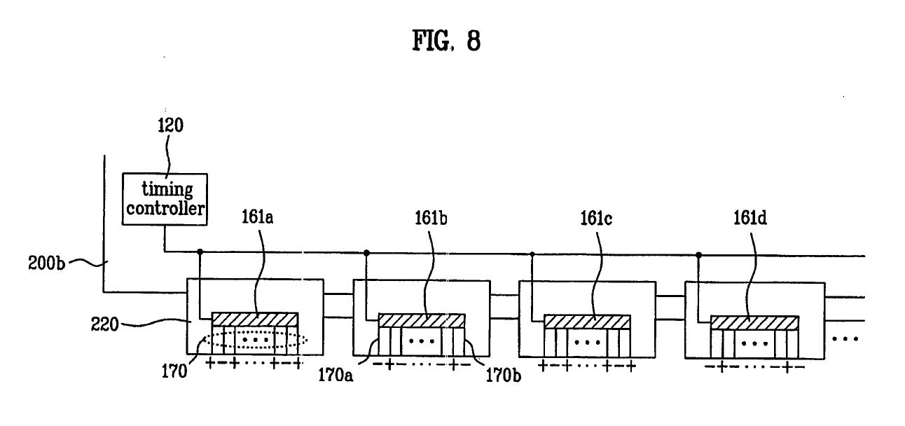

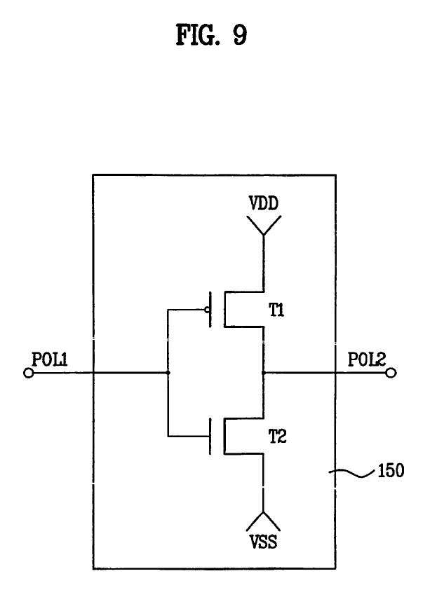

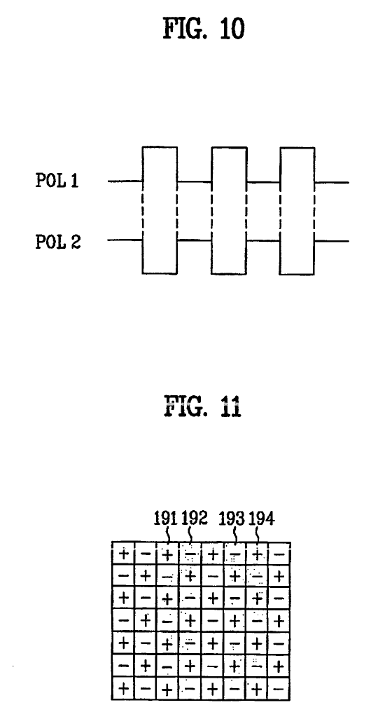

Hereinafter, a liquid crystal display device according to the present invention will be described referring to appended drawings. FIG. 6 illustrates a schematic diagram of a liquid crystal display device according to a first embodiment of the present invention. FIG. 7 illustrates a schematic diagram of a liquid crystal display device according to a second embodiment of the present invention. FIG. 8 illustrates a schematic diagram of a liquid crystal display device according to a third embodiment of the present invention. FIG. 9 illustrates a schematic diagram of a circuit structure of an inverter having a signal converter. FIG. 10 illustrates a timing diagram of first and second polarity reversing signals. FIG. 11 is a diagram illustrating a polarity pattern displayed on a liquid crystal panel when a drive IC of the present invention is used.

As illustrated in FIG. 6, the liquid crystal display device of the first embodiment of the present invention includes a liquid display panel 350 having a plurality of data lines (DL) arranged in one direction, a plurality of gate tape carrier package (TCP) for connecting a first surface of a non-display area 100a of the liquid crystal panel 350 with a gate printed circuit board (PCB) 200a, a gate drive IC 181 soldered into each of the gate TCPs 230 to drive the gate lines (GL), a plurality of data TCPs 220 for connecting a second surface of the non display area 100a of the liquid crystal panel 350 with a data PCB 200b, a plurality of data drive ICs 161a, 161b, 161c, and 161d, respectively soldered into each of the data TCPs 220, a timing controller 120 for applying a first polarity control signal (POL 1) to the first data drive ICs 161a and 161c positioned at an odd number ones among the plurality of data drive ICs 161a, 161b, 161c, and 161d, a signal reverser 150 receiving the first polarity control signal (POL 1) of the timing controller 120 and generating a second polarity control signal (POL 2) reversed from the first polarity control signal (POL 1), second data drive ICs 161b and 161d positioned at odd number ones among the plurality of data drive ICs 161a, 161b, 161c, and 161d.

Although it is not illustrated in the drawing, the liquid display device further includes a plurality of pixel electrodes formed in a matrix form in each pixel area defined by crossings of each gate line (GL) and each data line (DL) on a display of the liquid display panel 350, and a plurality of thin film transistors switched by a signal of the gate line (GL) and transmitting a data signal of the data line (DL) to the pixel electrode.

Each of the data drive ICs 161a, 161b, 161c, and 161d has an odd number of data signal output lines 170, and each of the data signal output lines 170 is one to one corresponding to each data line (DL) and is connected with each data line (DL). Accordingly, each of the data drive ICs 161a, 161b, 161c, and 161d divides the total data lines (DL) into odd numbers so as to drive the DLs. Each of the data drive ICs 161a, 161b, 161c, and 161d has the same odd number of output lines 170.

One of the data drive ICs 161b is described herein by way of example. The data drive IC 161b outputs a data signal in a dot inversion driving system, and thus a positive data signal and a negative data signal are alternately illustrated on the data signal output lines 170. The output lines 170 have different numbers of positive and negative data signals because the output lines 170 are odd number.

Provided five output lines 170 of the data drive IC 161b, +,−,+,−,+ data signals are sequentially output from each of the output lines 170, or −,+,−,+,− data signals are output.

Meanwhile, the signal reverser 150 may be provided in the timing controller 120 though it may be soldered in data PCB 200b as illustrated in FIG. 6. The signal reverser 150 may be provided in the data TCP 220 soldered in the data drive IC 161.

In this instance, the signal reverser 150 is provided in only even number data TCPs 220 having the second data drive ICs 161b and 161d soldered therein and positioned at even number data drive ICs among the data drive ICs 161a, 161b, 161c, and 161d.

The signal reverser 150 may be provided in odd number data TCPs having the first data drive ICs 161a and 161b soldered therein and positioned at odd number data TCPs 220 among the data drive ICs 161a, 161b, 161c, and 161d. As illustrated in FIG. 8, the signal reverser 150 may be provided in the data drive ICs 161a, 161b, 161c, and 161d.

In this instance, the signal reverser 150 is soldered only in the second drive ICs 161b and 161d to which the second polarity control signal POL 2 among the data drive ICs 161a, 161b, 161c, and 161d is applied. The signal reverser 150 may of course be soldered only in the first drive IC 161 to which the first polarity control signal POL 2 among the data drive ICs 161a, 161b, 161c, and 161d is applied.

Meanwhile, as illustrated in FIG. 9, the signal reverser 150 may be configured using an inverter including a PMOS transistor (T1) and an NMOS transistor (T2)

The signal reverser 150 receives the first polarity control signal (POL 1) of the timing controller 120 and outputs the second polarity control signal (POL 2) reversed from the first polarity control signal (POL 1).

In other words, as illustrated in FIG. 10, the first polarity control signal (POL 1) and the second polarity control signal (POL 2) alternatively have a high logic and low logic in the same time period. When the first control signal (POL 1) has high logic in an arbitrary time period, the second polarity control signal (POL 2) is low logic which is opposite to that of the first control signal (POL 1) due to the signal reverser 150. When the first polarity control signal (POL 1) has a low logic value, the second polarity control signal (POL 2) has a high logic value which is the opposite of the low logic value due to the signal reverser 150.

How a polarity pattern of each data drive ICs 161a, 161b, 161c, and 161d is changed by the POL 1 and the POL 2 will be described in detail as follows.

First, the POL 1 is applied to the first data drive ICs 161a and 161b among the data drive ICs 61a, 161b, 161c, and 161d, and the POL 2 is applied to the second data drive ICs 161b and 161d among the data drive ICs 161a, 161b, 161c, and 161d. The POL 1 and POL 2 are for selecting a polarity pattern of the data signal output from each of the data drive ICs 161a, 161b, 161c, and 161d. Since the POL 2 has the low logic value when the POL 1 has the high logic value, each of the first data drive ICs 161a and 161b receiving the POL 1 of high logic outputs a data signal of a first polarity pattern, and each of the second data drive ICs 161b and 161d receiving the POL 2 of the low logic value outputs a data signal of a second polarity pattern.

In this case, the data signals of the first polarity pattern and the second polarity pattern are patterns according to a dot inversion driving system. Accordingly, the first polarity pattern has alternating positive (+) and negative (−) data signals and the positive data signal arises first (+, −, +, . . . ).

The second polarity pattern shows alternating positive (+) and negative (−) data signals, and the negative data signal arises first (−, +, −, . . . ).

Accordingly, polarity of the data signal output from a first output line 170a of each of the first data drive ICs 161a and 161b and the polarity of the data signal output from a last output line 170b both have positive polarity because the output lines 170 of each of the first data drive ICs 161a and 161c receiving the first POL 1 of the high logic is the first polarity pattern, and each of the first data drive ICs 161a and 161c has an odd number of output lines 170.

The polarity of the data signal output from the first output line 170a of each of the second data drive ICs 161b and 161d and polarity of the data signal output from the last output line 170b both have negative polarity because the output lines 170 of each of the second data drive ICs 161b and 161d receiving the POL 2 of the low logic show the second polarity pattern, and each of the second data drive ICs 161b and 161d has an odd number of output lines 170.

Accordingly, the data signal output from the data drive ICs 161a, 161b, 161c, and 161d arranged in a row shows the first and the second polarity patterns alternatively.

Therefore, the polarity of the data signal output from the first output line 170a of the arbitrary data drive IC 161b and the polarity of the data signal output from the last output line 170b of the data drive IC 161a in a previous column are opposite to each other, and polarity of the data signal output from the last output line 170b of the arbitrary data drive IC 161b and polarity of the data signal output from the first output line 170a of the data drive IC 161c in a next column are opposite to each other.

As a result, when a liquid crystal panel 350 is operated using the data drive ICs 161a, 161b, 161c, and 161d, as illustrated in FIG. 11, a liquid crystal cell 192 receiving a data signal of the first output line 170a of the arbitrary data drive IC 161b and a liquid crystal cell 191 receiving a data signal of the last output line 170b of the data drive IC 161a in the previous column have opposite polarity, and a liquid crystal cell 193 receiving a data signal of a last output line 170a of the arbitrary data drive IC 161b and a liquid crystal cell 194 receiving a data signal of a first output line 170a of a data drive IC 161c in a next column have opposite polarity.

Hereinafter, the operation of the liquid crystal display device according to the present invention will be described in detail as follows.

In this instance, a first time period (T1) in which the POL 1 has high logic as illustrated in FIG. 10 will be described as follows. First, gate drive pulses are sequentially output from each of the gate drive ICs 181 so as to sequentially drive nth gate line (GL) from the first gate line (GL).

Thereafter, each of the data drive ICs 161a, 161b, 161c, and 161d applies the data signal to the liquid crystal cells arranged along the first gate line (GL) that received the gate drive pulse. In this instance, each of the data drive ICs 161a, 161b, 161c, and 161d selects a polarity pattern of the data signal in response to the POL 1 and POL 2 output from the timing controller 120.

In other words, each of the first data drive ICs 161a and 161c positioned at odd numbers among the data drive ICs 161a, 161b, 161c, and 161d applies liquid crystal cells of the first gate line (GL) in response to the POL 1 output from the timing controller 120.

In this instance, each of the liquid crystal cell groups connected with the output lines 170 and data lines (DL) of each of the first data drive ICs 161a and 161c among liquid crystal cells on a horizontal line arranged along the first gate line (GL) shows a first polarity pattern of +,−,+,−, . . . ,+ because the POL 1 has high logic during the first time period (T1) as illustrated in FIG. 10.

In this case, the liquid cell group means liquid crystal cells that are gathered corresponding to the output lines 170 of the one of the first data drive ICs 161a and 161c.

At the same time, each of the second data drive ICs 161b and 161d among the data drive ICs 161a, 161b, 161c, and 161d receives the POL 2 output through the timing controller 120 and the signal reverser 150 and applies the data signal to the liquid crystal cells of the first gate line (GL).

In this instance, each of the liquid crystal cell groups receiving outputs from each of the even number data drive ICs 161b and 161d among liquid crystal cells of a horizontal line arranged along the first gate line (GL) has a data signal of the second polarity pattern of −,+,−,+, . . . ,− because the POL 2 has low logic during the first time period (T1).

In this case, the liquid crystal cell group means liquid crystal cells that are gathered each corresponding to each of the output lines 170 of the one of the second data drive ICs 161b and 160d.

In the end, each of the total liquid crystal cells of the first horizontal line has polarity of +,−,+, . . . ,− so as to be driven with a dot inversion method.

Next, each of the odd number data drive ICs 161a and 161c among the data drive ICs 161a, 161b, 161c, and 161d receives the POL 1 of the timing controller 120 and applies the data signal to the liquid crystal cells arranged along the second gate line (GL).

In this instance, each of the liquid crystal cell groups receiving outputs from each of the first data drive ICs 161a and 161c among liquid crystal cells on a horizontal line arranged along the second gate line (GL) shows the second polarity pattern of −,+,−,+ . . . ,− because the POL 1 is low logic.

At the same time, each of the second data drive ICs 161b and 161d among the data drive ICs 161a, 161b, 161c, and 161d receives the POL 2 output through the timing controller 120 and the signal reverser 150 and applies the data signal of the first polarity pattern to the liquid crystal cells of the second gate line (GL).

Accordingly, each of the total liquid crystal cell groups receiving outputs of each of the second data drive ICs 161b and 161d among liquid crystal cells on a horizontal line arranged along the second gate line (GL) shows the first polarity pattern of +,−,+,−, . . . ,+.

In the end, each of the total liquid crystal cells of the first horizontal lines has polarity of +,−,+, . . . ,− in order so as to be driven with a dot inversion method.

Thereafter, the data signal applied to the liquid crystal cells arranged along each of the odd number gate lines (GL) including a third gate line (GL) has a same polarity pattern as the data signal applied to the liquid crystal cells of the first gate line (GL).

The data signal applied to the liquid crystal cells arranged along each of the odd number gate lines (GL) including a fourth gate line (GL) has a same polarity pattern as the data signal applied to the liquid crystal cells of the first gate line (GL).

Therefore, the total liquid crystal cells of the liquid crystal panel 350 are driven with the dot inversion method.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

The aforementioned liquid crystal display device and method of driving the same have effects as follows. The liquid crystal display device according to the present invention includes a signal reverser enabling to reverse a polarity control signal of a timing controller so as to reverse a first polarity control signal of the timing controller output and output a second polarity control signal.

The first polarity control signal is inputted into an odd numbered data drive IC such that the odd numbered data drive IC outputs a data signal of a first polarity pattern, and the second polarity control signal is inputted into an even numbered data drive IC such that the even numbered data drive IC outputs a data signal of a second polarity pattern reversed from the first polarity pattern.

Therefore, a flickering phenomenon is prevented from being generated between the liquid crystal cells corresponding to output lines positioned between adjoining data drive ICs.

1. A liquid crystal display device comprising:
a liquid crystal panel having a plurality of gate lines crossing a plurality of data lines;
a timing controller for outputting a first polarity control signal;
a signal reverser for outputting a second polarity signal reversed from the first polarity control signal;
a plurality of first data drive ICs receiving the first polarity control signal and outputting a data signal of a first polarity pattern to first data lines among the data lines; and
a plurality of second data drive ICs receiving the second polarity control signal and outputting data signals of a second polarity pattern to second data lines among the data lines, the second polarity pattern being contradictory to the first polarity pattern.

2. The liquid crystal display device of claim 1, wherein the first data drive ICs and the second data drive ICs are alternately positioned.

3. The liquid crystal display device of claim 1, wherein each of the first and second data drive ICs has an odd number of output lines.

4. The liquid crystal display device of claim 1, wherein the signal reverser is an inverter.

5. The liquid crystal display device of claim 4, wherein the signal reverser receives the first polarity control signal of the timing controller and outputs the second polarity control signal.

6. The liquid crystal display device of claim 4, wherein the signal reverser comprises the timing controller built therein.

7. The liquid crystal display device of claim 4, wherein the signal reverser is built in each of the second drive ICs.

8. A method of driving a liquid crystal display device comprising the steps of:
outputting a data signal of a first polarity pattern to first data lines among a plurality of data lines based on a first polarity control signal; and
outputting a data signal of a second polarity pattern to second data lines among the plurality of data lines based on a second polarity control signal, the second polarity pattern being contrary to the first polarity pattern.

9. The method of claim 8, wherein first data line groups including the first data lines and second data line groups including the second data lines are alternatively positioned.

10. The method of claim 9, wherein each of the first data line groups comprises an odd number of the first data lines, and each of the second data line groups comprises an odd number of the second data lines.
